(19) United States
(12) Patent Application Publication
(10) Pub. No.: US 2015/0301723 A1
(43) Pub. Date: Oct. 22, 2015

(54) NETWORK BASED METHOD AND APPARATUS FOR COLLABORATIVE DESIGN

(71) Applicant: ARMSTRONG WORLD INDUSTRIES, INC., Lancaster, PA (US)

(72) Inventors: JESSE C. ENGLE, Hershey, PA (US); JONATHAN M. Litofsky, Lititz, PA (US); JASON W. KICHLINE, Mechanicsburg, PA (US); FRANCIS P. LUKESH, Elizabethtown, PA (US)

(21) Appl. No.: 14/708,853

(22) Filed: May 11, 2015

Related U.S. Application Data
(63) Continuation of application No. 11/130,257, filed on May 17, 2005, now abandoned.

(51) Int. Cl. G06F 3/0484; H04L 12/18

(52) U.S. Cl. CPC G06F 3/04842; H04L 12/1822

(57) ABSTRACT

A method and apparatus are disclosed for collaborative design using a digital image. A networked system includes a web server, a database accessible by the web server, and a client computer connected with the web server for modifying a design set forth in a digital image and uploading a first modified version of the digital image. The web server hosts a web-based collaborative design application for modifying a room design depicted in a digital image, and published on a website hosted by the web server. The database stores information published on the website. The client computer can be used for designing a room based on a digital image of a room scene, and uploading the digital images, under control of a first user, to the web server. The collaborative design application is accessible by the first user to post the digital images for storage in the database, and is accessible via the Internet by a second user for posting of a redesign and comment.

### CROSS-REFERENCE TO RELATED APPLICATIONS

This application is a continuation of U.S. patent application Ser. No. 11/130,257 filed on May 17, 2005. The disclosure of the above application is incorporated herein by reference in its entirety.

### BACKGROUND

A web server is disclosed which hosts a web-based collaborative design application for modifying a design set forth in a digital image, and published on a web site hosted by the web server.

Known web sites host software which allows a user to access and manipulate a design accessed from the site. With these sites, a user can access digital imagery and, in some cases, can manipulate the imagery. The imagery can also, in some cases, be downloaded by the user.

### BRIEF SUMMARY

A method and apparatus are disclosed for collaborative design using a digital image. For example, a networked system includes a web server for hosting a web-based collaborative design application for modifying a design set forth in a digital image, and published on a web site hosted by the web server as a designed image and a database accessible by the web server, for storing information published on the web site. The collaborative design application is accessible by a first user to post the designed image for storage in the database, and is accessible via the Internet by a second user to create changes to the designed image for storage in the database as a redesigned image.

An exemplary method includes modifying a design set forth in a digital image, publishing the modified digital image on a web site as a designed image, storing published information relating to the designed image; and changing the designed image for storage as a redesigned image. The designed image, the redesigned image and comments can be separately posted to the web site for collaborative design.

Additionally, a computer-readable medium having a computer readable program code stored thereon is disclosed for collaborative design using a digital image. The computer readable program code implements a routine for preparing for publishing a modified digital image; a routine for finalizing publication of a modified digital image; a routine for inviting at least one participant to the web site for discussing the finalized publication of a modified digital image; and a routine for viewing discussion, wherein the finalized publication, comments and design modifications can be posted to the web site for collaborative design.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows an exemplary networked system for collaborative design using a digital image;

FIG. 2 shows an exemplary web page for registering a user with the web-based collaborative design application;

FIG. 3 shows an exemplary web page showing the user's postings of a designed room scene with a separate description of products depicted in the room design, along with the user's comments;

FIG. 4 shows an exemplary web page showing participants' redesign and comments based on the user's original posting;

FIG. 5 shows an exemplary workflow overview of the collaborative design application; and

FIG. 6 shows an exemplary web page with an exemplary view of selection menus for redesigning a posted room scene.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

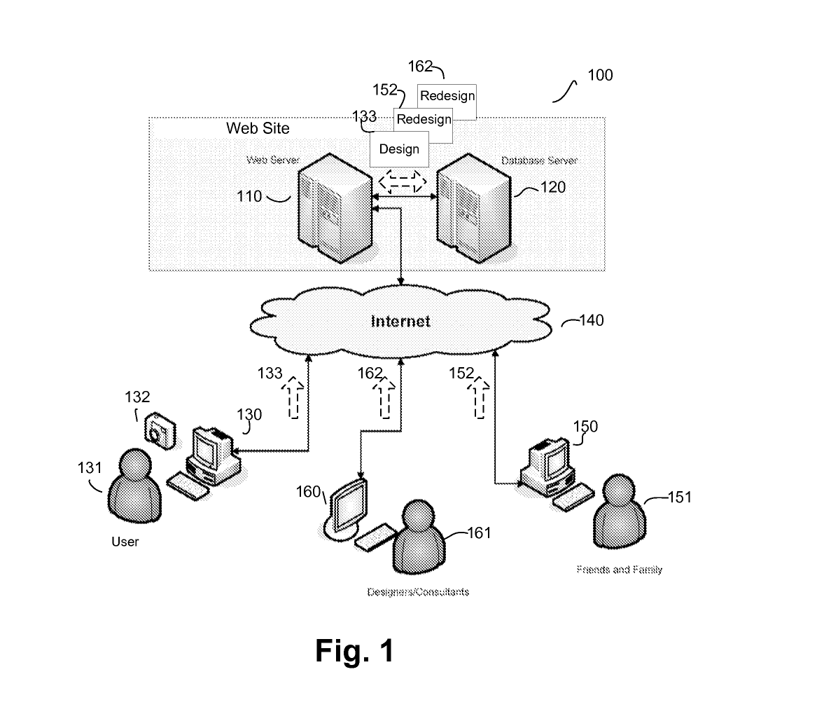

FIG. 1 shows an exemplary networked system 100 for collaborative design using a digital image. The networked system 100 includes a web server 110, a database, represented as including an exemplary database server 120 accessible by the web server 110, and a client computer 130 connected with the web server 110 via the Internet 140 for modifying a design set forth in a digital image 132 and uploading a first modified version of the digital image 133 as a designed image. The web server 110 hosts a web-based collaborative design application for modifying a design set forth in a digital image 132, and published on a web site hosted by the web server 110. The database server 120 stores information published on the web site. Those skilled in the art will appreciate that the database server and the web server can be a single server with an associated memory for storing the database.

The client computer 130 can be used for modifying a design set forth in a digital image 132 and uploading a designed image 133, under control of a first user 131, to the web server 110. The collaborative design application is accessible by the first user 131, e.g., via the client computer 130, to post the first modified version of the digital image 133 for storage in the database server 120.

The collaborative design application can be accessible via a second computer 150 under control of a second user 151 to create changes to the first modified version 152 for storage in the database server 120. Other participants 161, e.g., designers, consultants, friends and family, may access the web posting via other computers 160 to create other changes to the first modified version 162 for storage in the database server 120. Although these participants are shown with separate computers for illustrative purposes, it is not necessary for a participant to use a dedicated computer. Rather, any computer capable of accessing the Internet can be used by any or more of the disclosed users and participants.

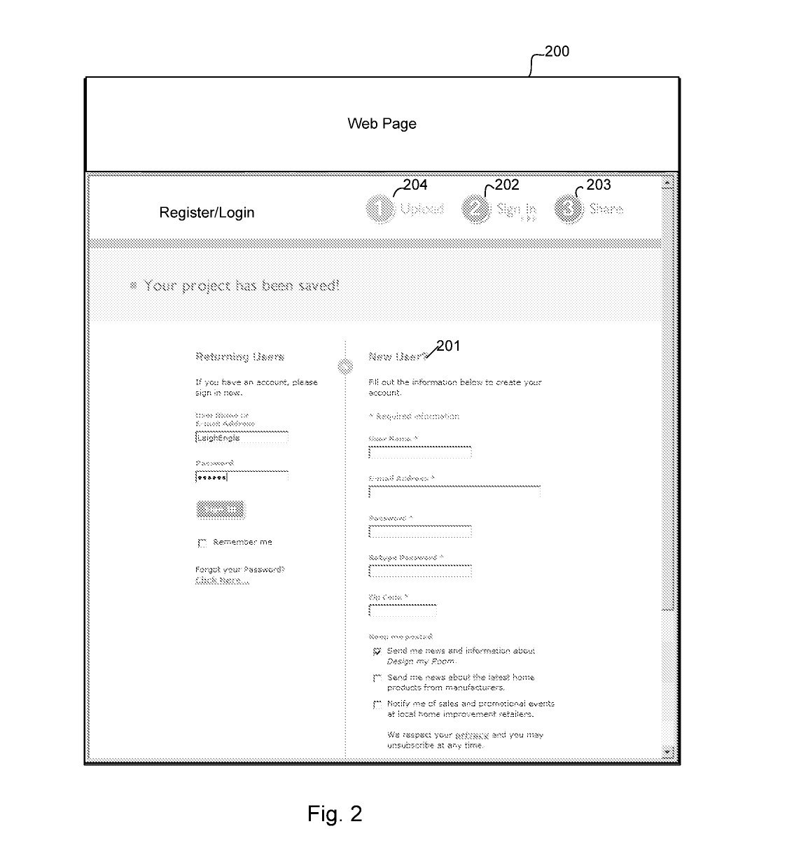

FIG. 2 shows an exemplary web page 200 for registering a user/participant with the web-based collaborative design application for private access. For example, as shown in FIG. 2, a new user can register 201 with the web-based collaborative design application via, e.g., the client computer 130 to sign in 202 and share 203 the upload 204 of information, including the modified version of the digital image 133. Likewise, a participant can also sign in with the web-based collaborative design application to discuss a posted room, e.g., post a redesign of an image or a comment. Alternatively, signing in can be excluded as a requirement for public posting, viewing and discussion.

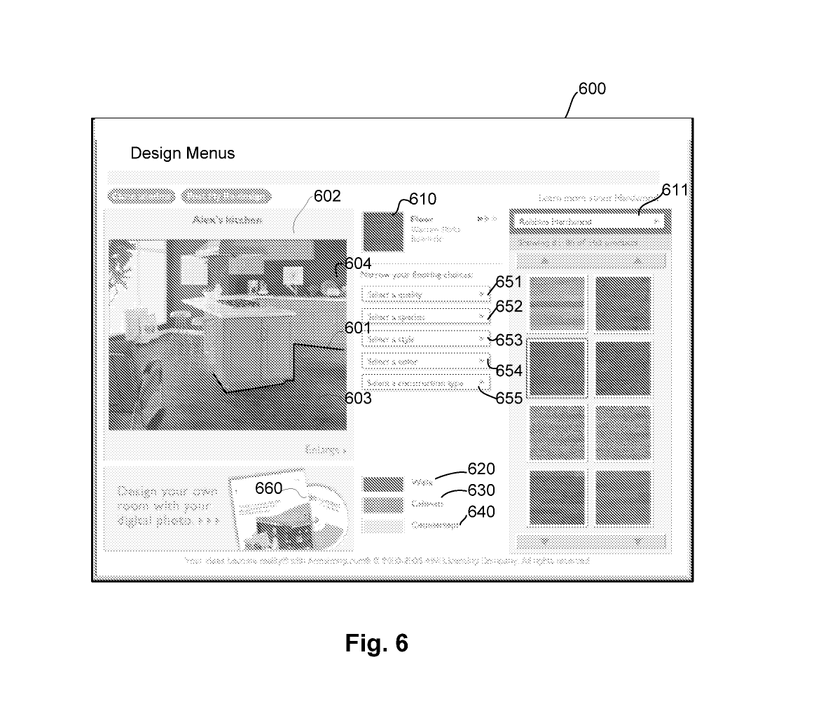

The client computer 130 can host a client software. The client software 660 of FIG. 6 may be provided for loading from at least one of the web server 110 and a computer-readable medium. The client software facilitates user-interactive functions, including tracing 601 a digital image 602 to define image surfaces; defining at least one of perspective and scale for an image surface 603 depicting a selected commercial product; and defining at least one of shadow and lighting conditions for an image surface 604 representing a painted surface of a selected paint color. Alternatively, these capabilities can be implemented in a web-based environment.

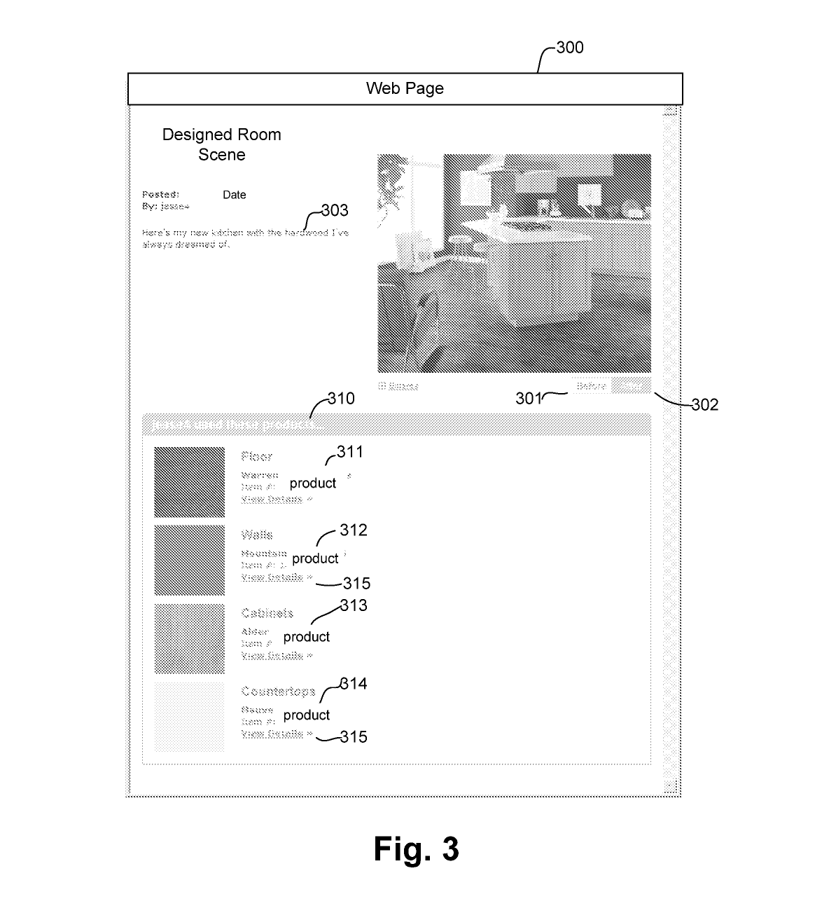

FIG. 3 shows an exemplary web page 300 showing an exemplary before-design 301 and after-design 302 postings of a designed room scene by the user with a separate description of products 310 depicted in the room design, along with the user's comments 303. As shown in FIG. 3, a commercial product is selected from groups of commercial products comprising, e.g., flooring products 311, wall-application products 312, cabinet products 313, and countertop products 314, a selected commercial product being associated with a view-details hyperlink 315 to a commercial product web site. The wall application 312 may be a paint color selected from a group of paint products, a selected paint color being associated with a view-details hyperlink 315 to a paint product web site. Other commercial products, e.g., ceiling decorative, application, and appliance products, are all within the scope of the present disclosure. The before-design 301 and after-design 302 postings of a room scene can be based on at least one of a digital photographic image of a room scene 132 provided by the first user 131 and a room scene available from the client software selected by the first user 131.

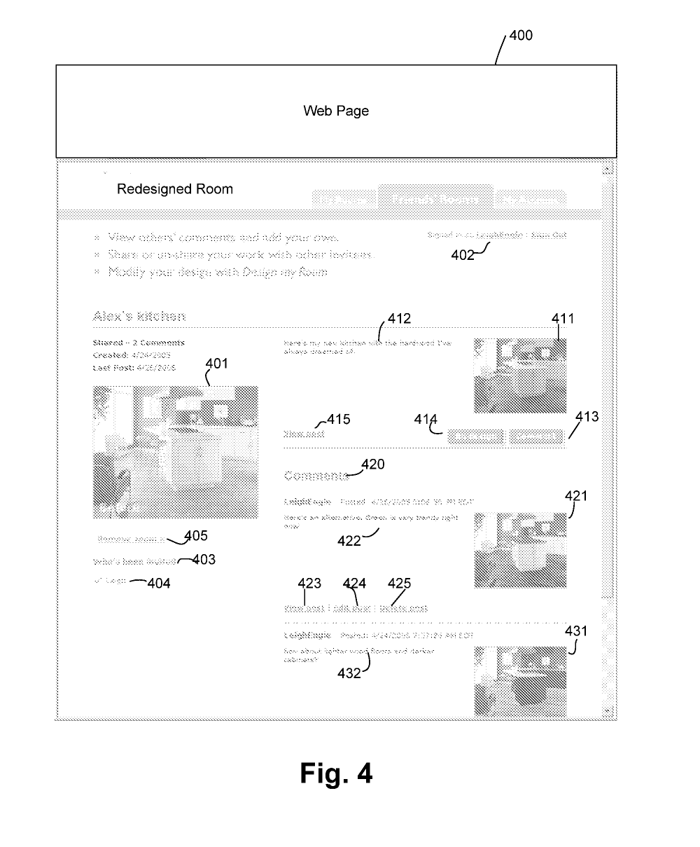

FIG. 4 shows an exemplary web page 400 with a second user's 402 posting of redesign and comments 420 based on the first user's original posting 401. As shown in FIG. 4, the web-based collaborative design application accepts a posting of at least one of a digital image 411 and textual comments 412 by the first user. The posted room can be removed 405. The web-based collaborative design application also accepts a comments 420 posting of at least one of a redesigned digital image (421, 431) and textual comments (422, 432) by a second user 402. A second user 402 selects a comment button 413 to create the textual comments (422, 432), and selects a re-design button 414 to create the redesigned digital image (421, 431). A second user 402, interacts with the web-based collaborative design application to view 423, edit 424 and delete 425 a comments 420 posting. Accordingly, the posting of a digital image can include, but not limited to, a posting of an image design 411, a digital image 401, and changes to the image design (421, 431) as an image redesign.

As further shown in FIG. 4, the collaborative design application facilitates invitation 403 by the first user to at least one invitee, 404, e.g., second user 402, to view the posted design 411 based on the digital image 401 and post to the web server at least one of comments (422, 432) and changes to the first modified version (421, 431). The first user posting 401 can be selected 415 to view the post.

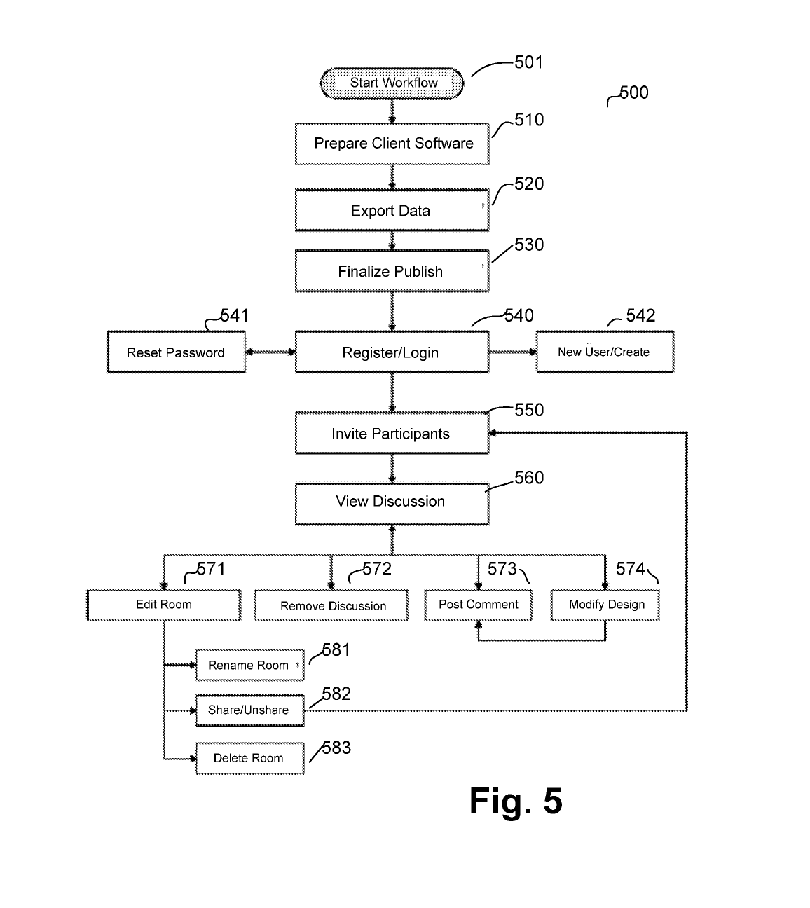

FIG. 5 shows an exemplary workflow overview 500 of the collaborative design application. The workflow illustrates an exemplary method for collaborative design using a digital image. An exemplary method starts workflow in block 501 with a user preparing a client software in block 510, including modifying a design set forth in a digital image. When a user chooses to publish the modified digital image on a web site as a first modified version, the prepared data is exported in block 520 from the client software. The client software then relinquishes control over to the web site, the control including storing published information relating to the modified digital image to finalize the publication 530. In block 540, a user is prompted to login to an account, or a new user is registered in block 542 with the web-based collaborative design application. Reset password capabilities in block 541 can also be provided. The first modified version of the digital image is posted with the web-based collaborative design application to share with invited participants 550. In block 571 of FIG. 5, the user can edit the posted room.

Client software can be acquired from at least one of the web server and a computer-readable medium to modify a design set forth in a digital image. See, e.g., 660 of FIG. 6. Upon loading of the client software to a user's client computer, the user can modify a design set forth in a digital image. For example, portions of the image can be traced in a manner as described herein to highlight regions in which different material selections, e.g., different floor coverings, can be substituted. To access a collaborative design application online, the client software accessed in block 510 can perform the steps of:
a) client software accesses a default web site to determine the web location to which data will be published; and
b) web server returns a web location, e.g., Uniform Resource Locator (URL), used to publish the files.

A digital image may be furnished by the user as a digital photographic image of a room scene, or the user may select a room scene from a stock of available room scenes. The client software provides a user capability to trace the digital image to define and identify a depicted surface, e.g., a floor, walls, cabinets, countertops, and a ceiling. Other traceable image features that are amenable to depiction/characterization are within the scope of the present disclosure. A selected surface can be associated with a material product, and at least one of perspective and scale can be set for the depicted material product. If the selected product is a paint product to depict a painted surface, at least one of shadow and lighting conditions for the depicted painted surface can be selected. See, e.g., 603 and 604 of FIG. 6. Although the image modify/design capabilities are described in the exemplary client software context, any visualization editor having like functionalities, including a web-based visualization editor, is within the scope of the present disclosure.

The exemplary method for the web-based collaborative design application accepts a posting of at least one of a digital image (520, 571, 574) and textual comments 573 by at least one of a user and at least one participant. The user exports data 520 to publish the design to the web and the at least one participant posts changes to the first modified version to modify the design 574. For example, the following steps can be taken to export data 520 from the client software:
a) User chooses to publish by selecting the “Publish” option in the client software;
b) client software generates a unique number, e.g., number derived from the date/time stamp and a user's serial number, such as a serial number of the client software;
c) client software locates the files that comprise the project, or any portion thereof, and formulates an HTTP post.;
d) client software submits the HTTP post data and reports to the user the upload status;
e) web server returns a URL once the upload is complete; and
f) client software opens the user's default web browser window with the URL returned.

When finalizing publication 530, client software relinquishes control over to the web site, the control including storing published information relating to the modified digital image to finalize the publication. To finalize publishing 530, one or more of the following steps can be taken:
a) Web server creates a new project based on the uploaded data and prompts the user for name and/or description of the project;
b) user enters project information;
c) web server saves the project changes;
d) web server prompts the user to create an account or sign in;
e) user signs in or creates an account;
f) web server associates the signed in user with the project;
g) user decides if they would like to share the project and if so, to invite participants;
h) web server saves privacy options; and
i) web server redirects the user to the newly created room.

The exemplary web publishing capabilities are described in an individualized private access-based context wherein a user or a participant logs into a web account to access the posted room at block 540. Alternatively, a room design can be openly published for public view and collaborative design, e.g., without the need for an account login, and such an open publication is within the scope of the present disclosure.

The exemplary method for the web-based collaborative design application implements sharing of the room by inviting the at least one participant 550 to view the first modified version posted to the web site using the collaborative design application. To invite a participant 550, the following exemplary steps can be taken:
a) User chooses to invite a participant to a discussion;
b) user enters e-mail addresses of the participant to invite;
c) user can type an optional message to be delivered to the Invitee;
d) web server composes and sends an e-mail to the invitee;
e) invitee receives the e-mail and clicks the link contained within; and
f) web server displays a view discussion web page 560, allowing the invitee to participate in the discussion.

Those skilled in the art will appreciate that any desired security measures can be associated with user and/or participant access. For example, users/participants may each have a respective level of security measure for the respective viewing and posting to a project, e.g., password access, encryption of transmitted data, etc. The individualized security-level access can affect the security level of the respective design/redesign posting, e.g., to a common project. For example, using appropriate security and/or encryption (e.g., PGP keys), a user can be provided access to all designs and redesigns. However, each participant can be given access to the user's publicly viewable design and their own redesign, but not given access to the redesigns of others (i.e., a limited, selectable access). As further shown in FIG. 5, participants can be invited to participate in a collaborative discussion in block 560, e.g., modify design in block 574 or provide comments in block 573. At least one participant accesses the web-based collaborative design application via the participant's computer to create changes to the first modified version for storage in the database server. The first modified version is published in block 530; changes to the name, content and settings of the room can be introduced in block 571; comments can be posted in block 573; and changes to the first modified version can be introduced in block 574. The foregoing information can be posted by the user to the web site for collaborative design. The user can rename the room/discussion in block 581, share or unshare in block 582, and remove/delete in block 583 a room/discussion using the collaborative design application. A participant can remove a discussion item from a participant's list of discussions 572; post comments 573; and make changes to the first modified version and post the changes 574.

View discussion 560 provides a participant or a user with web site capabilities to make changes to the first modified version, and post to the web site comments 573 and the changes to the first modified version 574. For example, the at least one participant is sent an email invitation providing a hyperlink to view the first modified version. To view a discussion, one or more of the following steps can be taken:
a) Web server displays the selected discussion to the user in a graphic format. The discussion is comprised of the original image, the modified design and other elements, including products used and posted comments;
b) user reviews the content and can choose edit room/discussion 571 or invite participants 550; and
c) user or participant reviews the content and can choose to post comment 573 or modify design 574.

When modifying design, in addition to the described product selections, an ability to retrace an image outline is within the scope of the present disclosure. For example, also within the scope of the present invention is the capability for a user or a participant to retrace a designed room, e.g., to trace an image outline overlooked in the user's design posting. See, e.g., 601 and 602 of FIG. 6.

To post comment 573, at least one of the following exemplary steps can be taken:
a) Participant chooses the discussion on which to post a comment;
b) participant enters plain text expressing his or her views, opinions, ideas, etc.;
c) participant chooses to post the comment;
d) web server applies the comment to the discussion with the appropriate time stamp and who made the comment;
e) web server determines if the participant has contributed to the discussion before. If not, the discussion is added to the participant's discussion list; and
f) web server sends an e-mail notification to the discussion owner (user) if requested.

To modify design 574, the following exemplary steps can be taken:
a) Participant chooses to make a change to the current design;
b) web server loads the initial design's image and mask data into the web-based visualization editor;
c) participant makes changes to the room design using the web-based visualization software;
d) participant chooses to save changes to the room design;
e) web server saves the design as a new revision and takes the user to post comment 573; and
f) web server associates the comment and the design revision.

FIG. 6 shows an exemplary web page 600 with an exemplary view of selection menus for redesigning a posted room scene. The exemplary room scene depicts selectable floor 610, walls 620, cabinets 630 and countertops 640. As further shown in FIG. 3, a material product is selected from commercial products 310 comprising, e.g., flooring products 311, wall-application products 312, cabinet products 313, and countertop products 314, a selected commercial product being associated with a view-details hyperlink 315 to a commercial product web site, including a paint product web site. Other traceable image features, e.g., a traceable ceiling feature capable of depicting a decorative, application, or appliance product, are all within the scope of the present disclosure. Returning to FIG. 6, a selected commercial product 611 can be characterized by a combination of quality 651, species 652, style 653, color 654 and construction type 655 selections. Although FIG. 6 depicts an view of selection menus in the form of an exemplary web page 600, any visualization editor capable of the exemplary functional features can be hosted by any processor, including, but not limited to, a computer (130, 160, 150) or a server (110, 120) in a standalone, networked, or a web-based environment for interactive use by any of the exemplary user/participants (131, 161, 151).

The disclosed system 100 executes a computer readable program code for collaborative design using a digital image. In one exemplary embodiment, a client software is hosted by a client computer 130. An exemplary client software implements functions for preparing client software for publishing a modified digital image 510 and exporting data from a client software 520. The exemplary client software then relinquishes control over to the web site for finalizing publication of a modified digital image 530. The user is prompted to login to his account 540 in order to associate the room to the user. Once logged in, the web-based collaborative design application can be used to invite at least one participant to the web site for discussing the finalized publication of a modified digital image 550. For example, a participant is invited to view the user's posting for discussion 560. The finalized publication 530, comments 573 and design modifications 574 can be posted to the web site for collaborative design.

The client software implements executable capabilities for user tracing of outlines of any portion of a digital image to define geometrical shapes within the image that correspond to depicted surfaces; user identification of a depicted surface as depicting, e.g., one of a floor, walls, cabinets and countertops; and/or user association of a material product with an identified depicted surface to depict the material product. Other traceable image features, e.g., a traceable ceiling feature capable of depicting a decorative, application, or appliance product, are all within the scope of the present disclosure. The digital image can be a digital photographic image of a room scene provided by the user, or it can be selected from a stock of available room scenes. The exemplary client software is capable of setting at least one of perspective and scale for the depicted material product, and setting at least one of shadow and lighting conditions for the depicted painted surface. The exemplary client software can be acquired as a download software product from a web site or as a computer-readable medium.

Alternatively, the exemplary client functionalities, including, but not limited to steps 510-530, can be implemented as an integrated web-based collaborative design application on a web site 110 for access by a user 131 from any networked computer. This alternative implementation can do away with the client software. The tools for design, upload and comments, including the image tracing capability, can be integrated into the web-based collaborative design application for interactive use by any of the user/participants (131, 151, 161) having an access to the web.

To associate a room with a user, a new user is registered 542 for login to the web-based collaborative design application. Password reset capabilities 541 can be provided. Login allows the user to publish a modified digital image as a designed image in his account. If the user chooses to share the room 550, at least one participant is invited to access the web-based collaborative design application to view and discuss the room 560. The web-based collaborative design application provides the viewer with online tools to modify designs (redesign), and post a comment 573 with the redesigned image 574.

Whether implemented as client software or as integrated web-based collaborative design application on a web site 110, users and participants can be provided with visualization editing capabilities, including, but not limited to, an image tracing capability 601 to trace a depicted surface outline 603; a capability to select a material product from groups of commercial products comprising, e.g., flooring products, wall-application products, cabinet products, countertop products, and ceiling products; and capabilities to post image designs, redesigns and comments to the web site. See, e.g., FIG. 6. As shown in FIG. 3, a selected commercial product 310 can be associated with a view-details hyperlink 315 to a commercial product web site; a selected paint product being associated with a view-details hyperlink to a paint product web site. The present disclosure encompasses a full range of outline tracing capabilities, including, but not limited to, a fully interactive image tracing, a rule-based semi-automated image tracing of depicted surface outlines, and an automated tracing of depicted surface outlines based on known machine intelligence methods, concepts and algorithms relating to image recognition. For example, the user can depress a mouse button, and in conjunction therewith, use the mouse to move a cursor along edges of an image to draw a line which can be used to define a geometric shape. See, e.g., line 601 of FIG. 6. Alternatively, any known edge/shape detection software can be used to identify geometric shapes within an image that correspond, for example, to desired regions (e.g., surfaces) within the image. For example a depicted surface in an image, e.g., representing a floor, can be traced using any of the foregoing tracing capabilities for identification as a depicted floor. At least one of perspective and scale can be set for an image surface depicting a material product; and at least one of shadow and lighting conditions can be set for an image surface representing a painted surface. Alternatively, any known technique for automatically setting scale and perspective of a depicted image can be used.

The computer readable program code for collaborative design using a digital image implements posting of at least one of a digital image (530, 571, 574) and textual comments 573 by at least one of the user and the at least one participant. For example, the finalized publication is posted to the web site by the user 530, and comments 573 and design modification 574 can be posted to the web site by the at least one participant.

The computer readable program code for collaborative design using a digital image implements user's invitation 550 of at least one participant to view the finalized publication posted to the web site. For example, at least one participant designated by the user is sent an email invitation with a hyperlink to view the user's posted finalized publication.

The foregoing computer readable program codes can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, a portable compact disc read only memory (CDROM), a mass storage, a server memory, a standalone storage device, a hard disk, a disk array, and a virtual storage device.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A networked system for collaborative design using a digital image, comprising:
a web server configured to host a web-based collaborative design application;
a database accessible by the web server for storing information; and
wherein the collaborative design application is configured to:
receive from a first user a digital photographic image of a room scene;
facilitate storage of the digital photographic image in the database;
trace an outline of a first surface depicted by the photographic image;
receive from the first user a first product selection for the first surface and provide a first modified photographic image that displays the first product selection being used for the first surface;
receive from a second user a second product selection for a second surface depicted by the photographic image, and provide a second modified photographic image that displays the second product selection being used for the second surface, wherein the first product selection is different from the second product selection; and
facilitate publication of the first and second modified photographic images on a web site hosted by the web server.

2. The networked system in accordance with claim 1, wherein the first user and the second user are registered with the web-based collaborative design application to sign in and share the first modified version of the digital image first and second modified photographic images.

3. The networked system in accordance with claim 1, further comprising:
a client computer under control of the first user, wherein the client computer includes client software acquired from at least one of the web server and a computer-readable medium.

4. The networked system in accordance with claim 1, wherein the collaborative design application is further configured to:
define at least one of perspective and scale for the displayed first product selection; or
define at least one of shadow and lighting conditions for the displayed first product selection.

5. The networked system in accordance with claim 4, wherein the web server includes:
a first view-details hyperlink to link a commercial product corresponding to the first product selection to a commercial product web site, wherein the first product selection is made from among a group of commercial products, the group comprising flooring products, wall-application products, cabinet products, countertop products, and ceiling products; and
a second view-details hyperlink to link a paint color corresponding to a third product selection to a paint product web site, wherein the third product selection is made from a group of paint products.

6. (canceled)

7. The networked system in accordance with claim 1, wherein the web-based collaborative design application posts textual comments provided by at least one of the first user and the second user.

8. (canceled)

9. The networked system in accordance with claim 1, wherein the collaborative design application, under control of the first user, invites the second user to view the first modified photographic image.

10. The networked system in accordance with claim 1, wherein the first surface is different from the second surface.

11. A method for collaborative design using a digital image, comprising:
receiving from a first user a digital photographic image of a room scene;
tracing an outline of a first surface depicted by the photographic image;
receiving from the first user a first product selection for the first surface and providing a first modified photographic image that displays the first product selection being used for the first surface:
receiving from a second user a second product selection for a second surface depicted by the photographic image, and providing a second modified photographic image that displays the second product selection being used for the second surface, wherein the first product selection is different from the second product selection; and
publishing the first and second modified photographic images on a web site hosted by the web server.

12. The method in accordance with claim 11, wherein the first user and the second user are registered with the web-based collaborative design application to sign in and share the first and second modified photographic images.

13. The method in accordance with claim 11, further comprising:
loading client software from at least one of the web server and a computer-readable medium to facilitate the tracing of the outline of the first surface.

14. The method in accordance with claim 11, further comprising:
identifying the first surface as depicting one of a floor, a wall, a cabinet, a countertop, and a ceiling; and
setting at least one of perspective and scale for the displayed first product selection; or
setting at least one of shadow and lighting conditions for the first product selection.

15. The method in accordance with claim 14, wherein:
a first view-details hyperlink links a material product corresponding to the first product selection to a commercial product web site, wherein the first product selection is made from among a group of commercial products, the group comprising flooring products, wall-application products, cabinet products, countertop products, and a ceiling product; and
a second view-details hyperlink links a paint product corresponding to a third product selection to a paint product web site, wherein the third product selection is made from a group of paint products, to a paint product web site.

16. (canceled)

17. The method in accordance with claim 11, wherein the web-based collaborative design application posts textual comments provided by at least one of the first user and the second user.

18. (canceled)

19. The method in accordance with claim 11, further comprising:
inviting, via the web site, the second user to view the first modified photographic image.

20. The method in accordance with claim 11, wherein the first surface is different from the second surface.

21. The networked system in accordance with claim 1, wherein the tracing of the outline is performed by the first user moving a cursor along an edge of the first surface.

22. The networked system in accordance with claim 1, wherein the tracing of the outline is automated.

23. A method for collaborative design, comprising:
receiving from a first user a digital photographic image of a room scene;
tracing an outline of a first surface depicted by the photographic image;
receiving from the first user a first product selection for the first surface and providing a first modified photographic image that displays the first product selection being used for the first surface;
receiving from the first user a perspective setting and a lighting setting for the displayed first product selection;
receiving from a second user a second product selection for the first surface and providing a second modified photographic image that displays the second product selection being used for the first surface, wherein the first product selection is different from the second product selection; and
publishing the first and second modified photographic images on a web site hosted by the web server
providing a first view-details hyperlink linking a material product corresponding to the first product selection to a commercial product web site;
providing a second view-details hyperlink linking a material product corresponding to the second product selection to the commercial product web site.

24. The method of claim 21, wherein the tracing of the outline is performed by the first user moving a cursor along an edge of the first surface.
